(19) United States
(12) Patent Application Publication
(10) Pub. No.: US 2015/0009249 A1
(43) Pub. Date: Jan. 8, 2015

(54) VIDEO DISPLAY DEVICE AND TELEVISION RECEIVING DEVICE

(71) Applicants: Yohei Kudo, Osaka-shi (JP); Kohji Iwasaki, Osaka-shi (JP)

(72) Inventors: Yohei Kudo, Osaka-shi (JP); Kohji Iwasaki, Osaka-shi (JP)

(73) Assignee: SHARP KABUSHIKI KAISHA, Osaka-shi, Osaka (JP)

(21) Appl. No.: 14/382,068

(22) PCT Filed: Sep. 6, 2012
(86) PCT No.: PCT/JP2012/072737

§ 371 Date: Aug. 29, 2014

(30) Foreign Application Priority Data
Mar. 1, 2012 (JP) 2012-045658

(51) Int. Cl. G09G 3/34; H04N 5/74; G09G 3/36

(52) U.S. Cl. CPC G09G 3/3406; G09G 3/36; H04N 5/7408; G09G 2320/066; G09G 2320/062
USPC 345/691; 345/690

(57) ABSTRACT

Provided is a video display device wherein a light emission luminance control is performed in accordance with a video signal corresponding to each of a plurality of divisional areas of a backlight. In the video display device: while power limiting control is being performed, the contrast can be improved and further the feeling of brightness for a high-luminance video can be increased; and even when an OSD image is displayed, display quality can be prevented from being degraded. A backlight control portion of the video display device defines a first luminance of LED for each divisional areas according to a first feature amount for a video indicated by a video signal after synthesizing of an OSD signal to be displayed in a display area corresponding to the divisional area, and controls the LED light emission by uniformly multiplying the first luminance by constant scale factor in a range where a total value of the LED drive current is equal to or less than a predetermined allowable current value. An OSD output portion (2) determines and outputs the OSD signal by use of gray scale data that is associated with a second feature amount of the video indicated by an input video signal to be displayed in a display area of the OSD image (or by an input video signal to be displayed in a display area corresponding to the divisional area including the display area of the OSD image).

### TECHNICAL FIELD

The present invention relates to a video display device and a television receiving device, and more specifically relates to a video display device that divides a backlight into areas to control light emission luminance for each area and a television receiving device.

### BACKGROUND OF THE INVENTION

In a video display device, one using an LED backlight for illumination of a display panel is prevalent. In the case of the LED backlight, there is an advantage that local dimming is possible. In the local dimming, a backlight is divided into a plurality of areas to control light emission of an LED for each area according to a video signal of a display area corresponding to each area. For example, such control becomes possible that light emission of the LED is suppressed for a dark part in a screen and the LED is caused to emit light with high intensity for a bright part in the screen. This makes it possible to reduce power consumption of the backlight as well as to improve contrast of a display screen.

Description will be given for exemplary control of conventional local dimming with reference to FIG. 18. Here, it is set that a backlight is divided into eight areas, and luminance of an LED is controlled according to a maximum gray level value of a video signal corresponding to each area. It is set that the maximum gray level value of the video signal of each area has a state shown in FIG. 18(A). A to H indicate area Nos. and a number below each of them is a maximum gray level value in each area.

For example, luminance of the LED in each area by the local dimming becomes as shown in FIG. 18(B). That is, luminance of the LED is controlled for each area according to the video signal of each area. Here, since a video is relatively dark in an area where the maximum gray level value of the video signal is low, the luminance of the LED is lowered to reduce black float and improve contrast as well as seek to reduce power consumption of the LED. In this case, when a current value to the LED is set to be constant, maximum luminance in each area is limited to luminance when all LEDs of the backlight are lit with an LED duty of 100% (for example, 450 cd/m²).

Because of such limit, even when trying to improve contrast, for example, by making a bright video much brighter uniquely by local dimming, there are limitations and it is impossible to increase contrast effectively. Thus, there is a demand for providing a high-quality video by further improving contrast than that of a conventional system when luminance of the LED is controlled by local dimming.

While light emission luminance of the LED in each area is dynamically controlled for each area independently in the local dimming, Patent Document 1 discloses a display device for area active drive for performing correct gray level display while suppressing power consumption by considering emitted light from ambient light sources. In the display device described in Patent Document 1, when luminance of a light source LS (x, y) is insufficient for illuminating a certain position (x, y) with required illuminance D (x, y) calculated by a required illuminance calculation portion, by setting, so as to compensate for the illuminance shortage rest by ambient light sources LS (x+p, y+q), luminance in these light sources, compared to a configuration where luminance of each light source is increased uniformly, power consumption is suppressed and illuminance shortage rest is compensated for, so that correct gray level display is performed.

Meanwhile, in a display device that realizes improvement of image quality and reduction of power consumption by optimizing screen luminance dynamically according to an input video signal, when an OSD (On Screen Display) image is superimposed, luminance of a display area of the OSD image fluctuates to thereby degrade display quality.

Patent Document 2 discloses a display device provided with a liquid crystal panel for displaying an input video signal by using a backlight light source, an APL detecting portion for detecting an APL (Average Picture Level) of the input video signal, a control microcomputer for dynamically and variably controlling light emission luminance of the backlight light source based on the detected APL, and an OSD portion for superimposing (synthesizing) a predetermined on-screen display image signal on the input video signal. Here, the control microcomputer maintains the light emission luminance of the backlight light source approximately constant regardless of the APL of the input video signal when displaying by superimposing the predetermined on-screen display image signal on the input video signal.

### PRIOR ART DOCUMENT

### Patent Documents

Patent Document 1: Japanese Laid-Open Patent Publication No. 2010-249996
Patent Document 2: Japanese Laid-Open Patent Publication No. 2005-321424

### SUMMARY OF THE INVENTION

### Problem to be Solved by the Invention

In a technology of conventional area active drive including the technology described in Patent Document 1, however, it is not considered to change a method for displaying an OSD image as showing an input source or the like depending on a video of a superimposing source. Accordingly, in the technology of conventional area active drive, when performing superimposing of an OSD image, (I) display is to be performed by determining light emission luminance of an LED in each area from a video on which the OSD image is superimposed or (II) even if it is assumed to apply the technology described in Patent Document 2, display is to be performed by determining light emission luminance of an LED in each area from a video before the OSD image is superimposed and simply superimposing the OSD image on a video that is displayed with the light emission luminance.

When the above-described control method (I) is employed, if conventional area active drive is performed while performing power limit control, peak luminance changes depending on presence/absence of the OSD image, and power consumption increases by contraries if power limit control is not performed. Here, the above-described power limit control is control in which limit is set to power consumption and light emission luminance of an LED (for example, a lighting rate of the LED) is selected so that peak luminance becomes maximum in a range not greater than the limit, and is for seeking reduction of power consumption and improvement of peak luminance by decreasing light emission luminance in a display area of a dark video without decreasing light emission luminance in a display area of a bright video compared to the local dimming.

For example, when a maximum gray level value of a video in a display area of an OSD image is low (that is, when being dark) and when the OSD image having the maximum gray level value higher than it is superimposed, light emission luminance in the display area (for example, a lighting rate of an LED) is to be increased in order to make the display area brighter. At this time, when the above-described power limit control is performed, light emission luminance of a bright part in other display area is to be decreased to the extent that power of the display area of the OSD image is increased so that power becomes equal before and after the display of the OSD image, resulting that display luminance (particularly, peak luminance) in other display area except for the display area of the OSD image is reduced. Moreover, when the above-described power limit control is performed and when a video signal indicating black for an entire screen is input, the lighting rate is not able to be decreased for the above-described other display area, so that excess power only becomes necessary by control for increasing light emission luminance in order to display the display area of the OSD image brighter and power consumption is increased.

By contraries, when a maximum gray level value of a video in a display area of an OSD image is high (that is, when being bright) and when the OSD image having the maximum gray level value lower than it is superimposed, light emission luminance in the display area (for example, a lighting rate of an LED) is to be decreased in order to make the display area darker. At this time, when the above-described power limit control is performed, light emission luminance of a bright part in other display area is to be increased to the extent that power of the display area of the OSD image is decreased so that power becomes equal before and after the display of the OSD image, resulting that display luminance (particularly, peak luminance) in other display area except for the display area of the OSD image increases. For example, also when a video signal indicating white for an entire screen is input, control is performed for decreasing light emission luminance in order to display the display area of the OSD image darker and increasing light emission luminance for the above-described other display area in which a white image is displayed, so that white luminance increases by switching from non-display to display for the OSD image and the change becomes prominent.

As to the above-described control method (II), in the technology described in Patent Document 2, aiming to prevent luminance of an OSD image from changing, backlight luminance is set not to change when the OSD image is displayed. Accordingly, when the above-described control method (II) is employed, regardless of whether power limit control is set or not set, backlight luminance is not to change at a time of displaying the OSD image, that is, area active drive is not to be performed at a time of displaying the OSD image, so that display quality becomes degraded compared to a case where the OSD image is not displayed.

As described above, when an OSD image is displayed in the technology of convention area active drive, when either method of (I) or (II) above is employed, display quality becomes degraded compared to a case where the OSD image is not displayed by influence of the OSD image.

The present invention has been made in view of circumstances as described above, and an object thereof is that in a video display device that divides a backlight into a plurality of areas to control luminance of the backlight according to a video signal corresponding to each area, while power limit control is being performed, a bright video is made much brighter so as to improve contrast and enhance feeling of brightness for a high-luminance video and further, even when an OSD image is displayed, display quality is prevented from being degraded.

### Means for Solving the Problem

To solve the above problems, a first technical means of the present invention is a video display device, comprising: an OSD output portion that outputs an OSD signal for displaying an OSD image; a synthesizing portion that synthesizes an input video signal and the output OSD signal; a display panel that displays a video in which the OSD image is superimposed on a video indicated by the input video signal based on the video signal synthesized in the synthesizing portion; a backlight that uses an LED as a light source for illuminating the display panel; and a backlight control portion that controls light emission of the LED for each of divisional areas which are areas that the backlight is divided into a plurality of areas, wherein the backlight control portion defines first luminance of the LED for each of the divisional areas according to a first feature amount for the video indicated by the synthesized video signal that is to be displayed in a display area corresponding to the divisional area, further, defines second luminance for each of the divisional areas by multiplying the first luminance for each of the divisional areas by constant scale factor for stretching uniformly in a range where a total value of LED drive current is equal to or less than a predetermined allowable current value in order to control light emission of the LED in each of the divisional areas based on the second luminance, and the OSD output portion obtains a second feature amount for the video indicated by the input video signal that is to be displayed in a display area of the OSD image, or a second feature amount for the video indicated by the input video signal that is to be displayed in a display area corresponding to the divisional area in which the display area of the OSD image is included, and uses gray level data associated with the second feature amount in advance to determine and output the OSD signal.

A second technical means is the video display device of the first technical means, wherein a table in which the gray level data is associated with the second feature amount is included, and the OSD output portion determines and outputs the OSD signal by referring to the table.

A third technical means is the video display device of the first or the second technical means, wherein the gray level data is data indicating gray level values of a background and a character, and the OSD output portion uses the gray level values of the background and the character associated with the second feature amount in advance to determine and output the OSD signal so that the OSD image is displayed with the gray level values of the background and the character.

A fourth technical means is the video display device of any one of the first to the third technical means, wherein a temporal filter for smoothing time-series variation in the second feature amount is included, and the OSD output portion uses the gray level data associated with the second feature amount in advance after passing through the temporal filter to determine and output the OSD signal.

A fifth technical means is the video display device of any one of the first to the fourth technical means, wherein both the first feature amount and the second feature amount are maximum gray level values of the video or average gray level values of the video.

A sixth technical means is the video display device of any one of the first to the fourth technical means, wherein the first feature amount is a maximum gray level value of the video and the second feature amount is an average gray level value of the video.

A seventh technical means is the video display device of any one of the first to the sixth technical means, wherein the backlight control portion further compares the second luminance for each of the divisional areas and a predetermined threshold, and, only for a divisional area where the second luminance is lower than the threshold, reduces the second luminance again to set as third luminance, and uses the third luminance and the second luminance in a divisional area where the second luminance is not reduced to control light emission of the LED for each of the divisional areas.

An eighth technical means is the video display device of any one of the first to the sixth technical means, wherein the backlight control portion further compares the second luminance for each of the divisional areas and a predetermined threshold, and, only for a divisional area where the second luminance is lower than the threshold, reduces the second luminance again so as to be equal to the first luminance in the divisional area, or to be lower than a predetermined multiple of the first luminance in the divisional area and lower than the threshold to set as third luminance, for a divisional area where the second luminance is equal to or greater than the threshold, assigns a total quantity of decrements of luminance in the divisional area lower than the threshold, and increases the second luminance by the assigned luminance to set as fourth luminance, and uses the third luminance and the fourth luminance to control light emission of the LED for each of the divisional areas.

A ninth technical means is the video display device of any one of the first to the eighth technical means, wherein the backlight control portion changes lighting rates in areas of the light source corresponding to the divisional areas based on the first feature amount for each of the divisional areas, obtains an average lighting rate that lighting rates of the areas of the light source are averaged for all areas of the light source, and determines the constant scale factor based on possible maximum display luminance on a screen of the display panel, which is associated with the average lighting rate in advance.

A tenth technical means is a television receiving device including the video display device of any one of the first to the ninth technical means.

### Effect of the Invention

According to the present invention, in a video display device that divides a backlight into a plurality of areas to control luminance of the backlight according to a video signal corresponding to each area, it is possible that while power limit control is being performed, a bright video is made much brighter so as to improve contrast and enhance feeling of brightness for a high-luminance video and further, even when an OSD image is displayed, display quality is prevented from being degraded.

### BRIEF DESCRIPTION OF DRAWINGS

FIG. 1 is a diagram describing one embodiment of a video display a device according to the present invention and shows an exemplary configuration of a main part of the video display device.

FIG. 2 is a diagram describing exemplary setting of a luminance stretch quantity by an area active control portion of the video display device of FIG. 1.

FIG. 3 is a diagram showing an example of a maximum gray level value in each area of a display screen which is divided into eight.

FIG. 4 is a diagram showing one example of a result of applying local dimming by power limit control with respect to respective areas A to H of FIG. 3.

FIG. 5 is a diagram showing a state of display luminance of a liquid crystal panel when an LED duty is changed.

FIG. 6 is a diagram showing another example of a result of applying local dimming under power limit control with respect to the respective areas A to H of FIG. 3.

FIG. 7 is a diagram in which light emission luminance of an LED obtained as a result of FIG. 6 is sorted in ascending order.

FIG. 8 is a diagram showing a gray level curve indicating light emission luminance of the LED in each divisional area with respect to a maximum gray level value in each divisional area, which is obtained from the light emission luminance of the LED of FIG. 7.

FIG. 9 is a diagram describing a result of conventional area active drive when a maximum gray level value of an OSD-containing area video is low.

FIG. 10 is a diagram describing a result of conventional area active drive when a maximum gray level value of an OSD-containing area video is high.

FIG. 11 is a diagram describing exemplary processing in an OSD output portion of the video display device of FIG. 1.

FIG. 12 is a diagram describing exemplary processing when an OSD image different from that of FIG. 11 is displayed.

FIG. 13 is a diagram describing exemplary processing when an OSD image different from those of FIG. 11 and FIG. 12 is displayed.

FIG. 14 is a diagram showing one example of a gray level table in the video display device of FIG. 1.

FIG. 15 is a diagram showing one example of a video that is output by using the gray level table of FIG. 14.

FIG. 16 is a diagram describing a function of a temporal filter that is able to be incorporated in the video display device of FIG. 1.

FIG. 17 is a diagram showing another example of a gray level table in the video display device of FIG. 1.

FIG. 18 is a diagram describing exemplary control of conventional local dimming.

### PREFERRED EMBODIMENT OF THE INVENTION

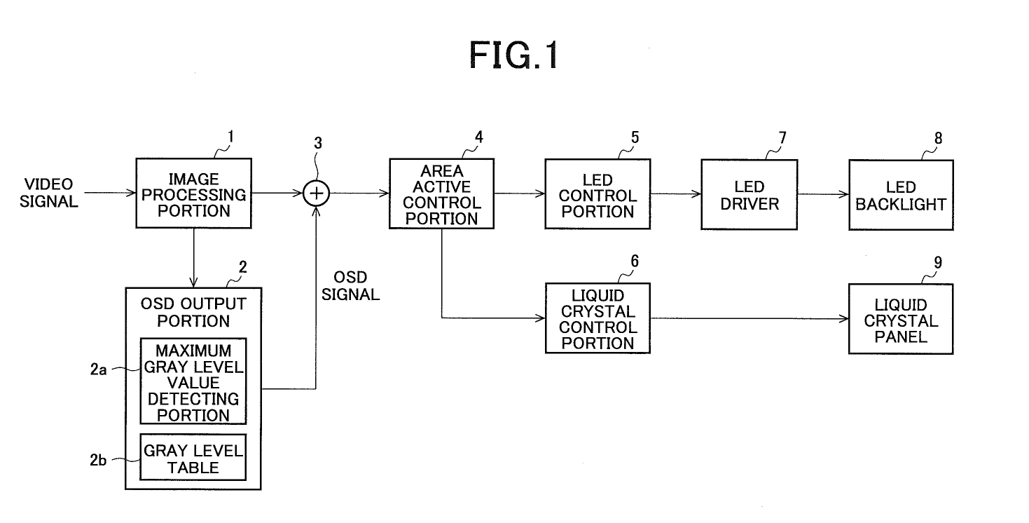

FIG. 1 is a diagram describing one embodiment of a video display a device according to the present invention and shows an exemplary configuration of a main part of the video display device. The video display device has a configuration that applies image processing to an input video signal for video display, and is able to be applied to a television receiving device or the like.

The video display device illustrated in FIG. 1 is provided with an image processing portion 1, an OSD output portion 2, a synthesizing portion 3, an area active control portion 4, an LED control portion 5, a liquid crystal control portion 6, an LED driver 7, an LED backlight 8, and a liquid crystal panel 9. Note that, a part of the area active control portion 4, the LED control portion 5 and the LED driver 7 for controlling light emission of the LED backlight 8 correspond to an example of the above-described backlight control portion of the present invention.

The image processing portion 1 inputs a video signal separated from a broadcast signal or a video signal input from external equipment and performs the same conventional video signal processing to output to a next stage. For example, IP conversion, noise reduction, scaling processing, γ adjustment, white balance adjustment and the like are executed as appropriate. Moreover, contrast, color hue and the like are adjusted based on a user setting value for outputting. Note that, though it is not described specifically in particular, the area active control portion 4 may execute γ adjustment, white balance adjustment and the like by performing feedback of control of light emission luminance of an LED.

When displaying an OSD image, the OSD output portion 2 determines and outputs an OSD signal for displaying the OSD image. The present invention has a main feature in a method for determining this OSD signal, and the feature thereof as well as a maximum gray level value detecting portion 2a and a gray level table 2b included in the OSD output portion 2 will be described below. Switching of display/non-display of the OSD image and switching of the OSD image are executed based on an operation signal indicating a switching operation from a not-shown user operation portion. Instead, switching described above may be performed based on any of default setting of a liquid crystal display device, preliminary user setting from the user operation portion, and information that is stored at a time of previous video display. For example, information indicating that an OSD image P is displayed just before power is turned off in a previous time, and the like correspond to the information that is stored at the time of previous video display. In this example, switching may be performed so that the information is read when power is turned on, and in accordance with previous turning off of power, the OSD image P is displayed.

The synthesizing portion 3 inputs the video signal output from the image processing portion 1, and synthesizes the input video signal and the OSD signal output by the OSD output portion 2, that is, superimposes the OSD signal on the input video signal to output to the area active control portion 4. When display of the OSD image is not performed, the video signal output from the image processing portion 1 is to be input to the area active control portion 4 as it is.

The area active control portion 4 controls light emission of the LED via the LED control portion 5 and the LED driver 7 for each area that the LED backlight 8 (a lighting area of the LED backlight 8) is divided into a plurality of areas (hereinafter, referred to as a divisional area). The LED backlight 8 is a backlight using an LED as a light source for illuminating the liquid crystal panel 9, and a plurality of LEDs are disposed as the light source.

Specific exemplary assignment of light emission control will be described. First, the area active control portion 4 determines light emission luminance of the LED for each divisional area and outputs data indicating the light emission luminance (hereinafter, referred to as LED data) to the LED control portion 5. This determining method will be described below. Subsequently, the LED control portion 5 determines a current value and/or a driving duty of the LED (hereinafter, referred to as an LED duty) for performing control of the LED backlight 8 so as to have light emission luminance indicated by the LED data for each divisional area, to pass to the LED driver 7. The LED driver 7 is configured not only so as to be able to drive each LED at constant current but configured so to be able to perform control for changing a current value of the drive current (current gain control) and/or PWM (Pulse Width Modulation) control, and drives the LED (LED in the divisional area) at the current value and/or the LED duty, which have been received, for light emission for each divisional area.

Moreover, the area active control portion 4 generates liquid crystal data to be displayed on the liquid crystal panel 9 from the video signal input from the synthesizing portion 3 to output to the liquid crystal control portion 6. Here, the liquid crystal data is data indicating a gray level of each pixel of the liquid crystal panel 9, and the liquid crystal data and the LED data are output so that synchronization of the LED backlight 8 and the liquid crystal panel 9 for final output is kept. Note that, the liquid crystal panel 9 is one example of a display panel and the liquid crystal control portion 6 is one example of a display control portion that performs display control of the display panel. In the case of synthesizing the OSD image, the liquid crystal panel 9 is to display, based on the video signal synthesized by the synthesizing portion 3, a video in which the OSD image is superimposed on the video indicated by the input video signal. Note that, the display panel used in the video display device of the present invention is not limited to the liquid crystal panel 9 as long as being a non-self-luminous display panel.

Next, specific description will be given mainly for a method for determining light emission luminance for each divisional area as to light emission control for each divisional area in the area active control portion 4.

First, the area active control portion 4 defines first luminance of the LED in each divisional area according to a first feature amount for a video to be displayed in a display area corresponding to the divisional area (video indicated by a video signal after being synthesized with an OSD signal). More specifically, the area active control portion 4 divides the video signal output from the image processing portion 1 into the above-described divisional areas, and extracts the first feature amount of the video for each divisional area. Of course, when synthesizing of an OSD image is not performed, the video to be displayed in the display area corresponding to the divisional area refers to a video indicated by an input video signal (in this example, the video signal output from the image processing portion 1).

Description will be given by taking an example in which a maximum gray level value of the video is employed as the above-described first feature amount, which may be other predetermined statistic such as an average gray level value of the video. Note that, this average gray level value may be said as an APL of a corresponding area (the display area corresponding to the divisional area), and as an example of the APL, an average value of luminance values calculate from gray level values of respective colors or a so-called “average luminance level” which is an average value of gray level values of a representative color such as green is also able to be employed.

The above-described first luminance may be defined by a predefined operation expression as a lighting rate of the LED in the divisional area in the LED backlight 8. In this operation expression, basically, for such a divisional area that the first feature amount indicates a high-gray-level (that is, bright) value, the lighting rate is made high so that light emission luminance of the LED becomes high, and for such a divisional area that it indicates a low-gray-level (that is, dark) value, the lighting rate is made low so that light emission luminance of the LED becomes low. The lighting rate is defined for each divisional area, and the lighting rate referred to here is actually changed as described below, and may be said as having a provisional value.

The area active control portion 4 further multiplies the above-described first luminance (which may be a value obtained as the above-described provisional lighting rate) in each divisional area by constant scale factor for stretching uniformly in a range where a total value of LED drive current is equal to or less than a predetermined allowable current value, thereby defining second luminance in each divisional area. That is, the area active control portion 4 performs power limit control for the above-described first luminance to determine light emission luminance of the LED for each divisional area of the LED backlight 8. The power limit control is for further enhancing luminance of the backlight with respect to an area that needs more luminance in a display screen to improve contrast, and stretching (that is, increasing) light emission luminance of the LED with the constant scale factor in a range where a total value of drive current of all LEDs of the LED backlight 8 is equal to or less than the predetermined allowable current value. For example, a total quantity of drive current when the LEDs of the LED backlight 8 are completely lit is set to an upper limit, and light emission luminance of the LED is increased in a range where a total quantity (total value) of drive current of the LEDs that are lit in each divisional area does not exceed the above-described total quantity of drive current when completely lit. Note that, a method for determining the above-described constant scale factor will be described below.

The area active control portion 4 outputs LED data indicating the above-described second luminance to the LED control portion 5 so as to control light emission of the LED in each divisional area based on the above-described second luminance that is defined for each divisional area in this manner. Then, when the LED control portion 5 controls each LED of the LED backlight 8 via the LED driver 7, it is possible to cause the LED in each divisional area to emit light with the above-described second luminance.

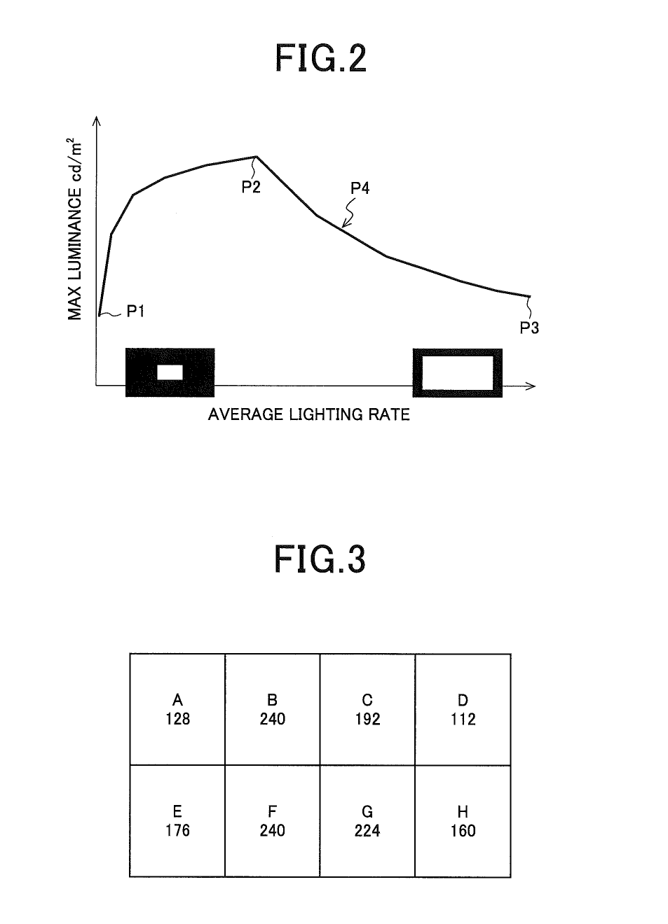

Description will be given for the constant scale factor to be multiplied by the above-described first luminance for stretching uniformly and a specific example for multiplying the constant scale factor, with reference to FIG. 2 to FIG. 8. Here, description will be given by taking an example in which the first luminance is obtained as the provisional lighting rate as well. This constant scale factor is able to be expressed by a stretch quantity or a stretch proportion of maximum light emission luminance (hereinafter, referred to as a luminance stretch quantity).

First, description will be given for one example of luminance stretch processing in the area active control portion 4 with reference to FIG. 2.

The area active control portion 4 calculates an average lighting rate of the entire LED backlight 8 from the provisional lighting rate of each divisional area, and according to the average lighting rate, calculates a luminance stretch quantity of the LED backlight 8 with a predetermined operation expression. This predetermined operation expression has power limit control added and is an expression to have a range in which a total value of drive current of LEDs is equal to or less than the predetermined allowable current value.

In the area active control portion 4, by stretching maximum light emission luminance of the LED backlight 8 (maximum light emission luminance of the LED) only by this luminance stretch quantity, it is possible to stretch possible maximum screen luminance in all areas in a screen from reference luminance only by a predetermined quantity. This reference luminance serving as a source for stretching is such luminance that screen luminance is 450 (cd/m²) in the case of a maximum gray level value, for example. This reference luminance is able to be defined as appropriate without limiting to this example.

Hereinafter, possible maximum screen luminance after stretching in the case of the maximum gray level value in all areas in the screen, that is, a possible maximum value of screen luminance after stretching is referred to as “Max luminance”. Note that, in the case of 8-bit representation, a pixel having a gray level value of 255th gray level has the highest screen luminance in the screen, which serves as the possible maximum screen luminance (Max luminance). As described above, since the luminance stretch quantity is a value that is able to be determined by the average lighting rate, and the Max luminance is a value that is able to be determined by the luminance stretch quantity, the Max luminance may be said as a value that is able to be determined according to the average lighting rate as illustrated with a graph of FIG. 2. Note that, FIG. 2 is a diagram describing exemplary setting of the luminance stretch quantity by the area active control portion 4, and shows one example of a graph showing a relationship of Max luminance (cd/m²) to an average lighting rate (window size) of the LED backlight 8. A horizontal axis in the graph of FIG. 2 is an average lighting rate of the backlight, in which the average lighting rate is 0 in a state of having no lit area and the average lighting rate reaches 100% in a state of completely lit.

Further, the area active control portion 4 in this example performs control so as to increase the Max luminance as decreasing from a position of P3 (average lighting rate of 100%) as indicating the relationship of the average lighting rate and the Max luminance with the graph of FIG. 2. This shows that the screen luminance is not increased up to the Max luminance depending on a gray level value of a pixel even with the same average lighting rate. Moreover, such control in the area active control portion 4 results from that power for lighting the LED (a total quantity of drive current values) is made constant by power limit control, and as the average lighting rate increases, power that is able to be supplied to a single divisional area becomes small and the Max luminance also becomes small. Moreover, the higher average lighting rate leads to stretching of luminance of the backlight at a smaller degree, that is, to be suppressed, so that there is an effect of preventing that an originally bright screen appears rather dazzlingly by excessively providing the luminance of the backlight.

In the graph of FIG. 2, it is set that the value of the Max luminance becomes the largest with the average lighting rate at P2, and the maximum screen luminance at this time is 1500 (cd/m²). That is, in the case of P2, the possible maximum screen luminance is to be stretched up to 1500 (cd/m²) compared to the reference luminance when completely lit (in the example described above, 450 cd/m²). Note that, the maximum screen luminance is not limited thereto, and is able to be determined within a range of capability of the LED backlight 8.

P2 is set to a position having a relatively low average lighting rate. That is, luminance of the backlight is stretched up to 1500 (cd/m²) in the case of a totally dark screen which has a low average lighting rate and partially has a peak with a high gray level.

Then, as described above for P3, as the average lighting rate becomes higher than P2, the divisional area to be lit increases, so that power that is able to be supplied to each LED is reduced by power limit control, resulting that the possible maximum luminance of the divisional area is also reduced gradually. P3 shows a state where the entire screen is completely lit, and in this case, each LED has an LED duty reduced by 36.5%, for example.

On the other hand, since it is possible to concentrate power to the LED of the divisional area to be lit in a range where the average lighting rate is particularly small, each LED is able to be lit up to the maximum luminance having an LED duty of 100%, while in a range where the average lighting rate is small (P1 to P2), the Max luminance is reduced as the average lighting rate decreases so that the Max luminance becomes lowest when the average lighting rate is 0 (P1) for suppressing black float. That is, the range where the average lighting rate is low corresponds to a video in a dark screen, and it is preferable to keep display quality, rather than by increasing screen luminance by stretching the luminance of the backlight, by suppressing the luminance of the backlight to the contrary to improve contrast and suppress black float, so that such setting for suppressing black float in the low average lighting rate is employed and the value of the Max luminance is gradually reduced from P2 to P1 (average lighting rate is 0, that is, perfect black).

Note that, like the graph of FIG. 2, it may be determined such that the Max luminance becomes smaller than the reference luminance in a range where the average lighting rate is small, and in this case, it is indicated that the luminance stretch quantity becomes negative. Like this example, even when there is a situation where the luminance stretch quantity becomes negative depending on the average lighting rate, it may be said that the maximum light emission luminance and the maximum screen luminance (that is, maximum display luminance) are strengthened by “stretching” on the whole, if an integral value that the graph of the Max luminance of FIG. 2 is integrated over the all average lighting rates is made larger than an integral value that the reference luminance is integrated over the all average lighting rates.

In this manner, it is preferable that, for each divisional area of the LED backlight 8, the area active control portion 4 changes a lighting rate in an area of the light source corresponding to the divisional area based on the first feature amount of a video (the video after being synthesized with an OSD image, which is to be displayed in a display area corresponding to the divisional area) by a video signal after being synthesized with an OSD signal, obtains an average lighting rate that lighting rates of areas of the light source are averaged for all of the areas of the light source, and stretches luminance of the light source to constant scale factor based on possible maximum display luminance (Max luminance) on a screen of the liquid crystal panel 9 which is associated with the average lighting rate in advance.

In this manner as described above, the area active control portion 4 stretches the lighting rate (provisional lighting rate) for each area described above so that luminance of the LED becomes the above-described second luminance (which is not to be common luminance in the divisional areas) in accordance with the graph of FIG. 2, for example, to output to the LED control portion 5 as LED date of each divisional area.

Next, description will be given for one example of a method for determining the above-described constant scale factor in the area active control portion 4 by taking a specific example of the first feature amount with reference to FIG. 2 to FIG. 5.

FIG. 3 is a diagram showing an example of a maximum gray level value in each area of a display screen which is divided into eight. The respective areas illustrated in FIG. 3 correspond to the above-described divisional areas of the LED backlight 8, and each area No. is set as A to H. In this example, maximum gray level values of a video in the eight areas A to H are 128, 240, 192, 112, 176, 240, 224 and 160, respectively.

The area active control portion 4 calculates a provisional lighting rate of the LED of the backlight in an area from a maximum gray level value in the area for each of the areas A to H. The provisional lighting rate is a lighting rate corresponding to the above-described first luminance, and is able to be indicated by, for example, an LED duty. In this case, a maximum value of the provisional lighting rate is 100%. Note that, an example in which luminance of the LED is changed only by PWM control is taken in the following description for simplification of the description. When the final LED duty exceeds 100% by luminance stretching, however, such as increase of a current value may be performed by using current control in combination. Alternatively, by considering proportion for performing luminance stretching, an inverse number of an increment by luminance stretching may be multiplied in advance. For example, when the Max luminance increases from 450 (cd/m²) to 1500 (cd/m²) by applying luminance stretching to the utmost extent, processing for multiplying the LED duty as the provisional lighting rate by 450/1500 (=30%) or the like may be applied.

The provisional lighting rate of the LED in each area is calculated in accordance with a predefined operation expression. In this operation expression, as described above, basically, for such a divisional area that the maximum gray level value indicates a high-gray-level (that is, bright) value, the lighting rate is made high so that light emission luminance of the LED becomes high, and for such a divisional area that it indicates a low-gray-level (that is, dark) value, the lighting rate is made low so that light emission luminance of the LED becomes low.

As one example, in the case of being represented by 8-bit data with a gray level value of a video of 0 to 255, when exemplifying a case where the maximum gray level value is 128 as the area A of FIG. 3, the lighting rate of the LED does not remain at 100% but is reduced to (1/(255/128))^{2.2}=0.217 time (21.7%). In this example, γ correction is considered. Thereby, the provisional lighting rates of the LEDs in the eight areas A to H of FIG. 3 are obtained as 21.7%, 87.5%, 53.6%, 16.4%, 44.2%, 87.5%, 75.2%, and 35.9%, respectively. Note that, an average value of these provisional lighting rates is about 53%. As a different example, the provisional lighting rates of the LEDs in the eight areas A to H of FIG. 3 may be simply obtained as 50.2% (=128/255), 94.1% (=240/255), 75.3% (=192/255), 43.9% (=112/255), 69.0% (=176/255), 94.1% (=240/255), 87.8% (=224/255), and 62.7% (=160/255), respectively. Note that, an average value of these provisional lighting rates in the different example described above is about 72%. The operation expression for obtaining the provisional lighting rate is not limited to these examples.

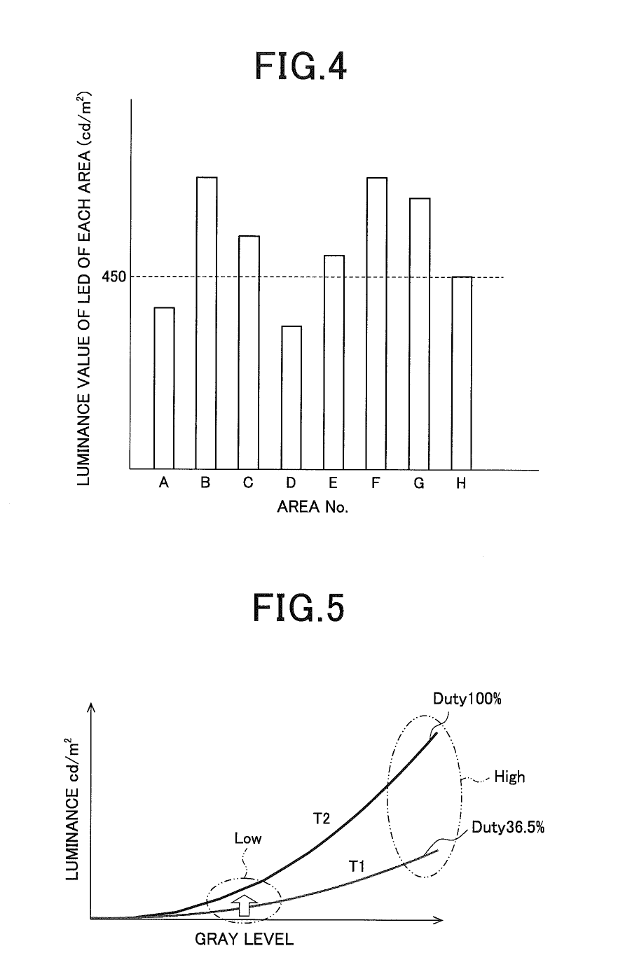

FIG. 4 shows an example of a result of applying local dimming under power limit control with respect to the respective areas A to H of FIG. 3. In FIG. 4, a horizontal axis is an area No. of the divisional area shown in FIG. 3 and a vertical axis is a luminance value of the LED of each divisional area. The luminance value of the LED is able to be expressed by a gray level value of 0 to 255. Moreover, here, description will be given for a case where a result of obtaining light emission luminance of the LEDs in the respective areas A to H according to the maximum gray level values of the respective areas A to H illustrated in FIG. 3 is the provisional lighting rate shown in one example above.

The area active control portion 4 averages the provisional lighting rates of the backlight for each area, which are calculated from the maximum gray level values of a video signal, and calculates an average lighting rate of the LED backlight 8 in one video frame. The calculated average lighting rate of an entire screen of course becomes high as an area having the high provisional lighting rate increases in each area. In one example above, the average lighting rate of the entire screen is calculated as about 53%.

The area active control portion 4 then performs processing for multiplying the light emission luminance of the respective areas A to H by the constant scale factor (a-times) to enhance luminance. The condition at this time is a total quantity of drive current values of each area <a total drive current value when LEDs are completely lit.

To describe specifically, a value when the average lighting rate is 53% (P4) in the graph of FIG. 2 is employed as the Max luminance. It is set that the LED duty corresponding to the luminance of the LED backlight in a divisional area that possibly has maximum luminance is 55% when the average lighting rate is 53% (P4) in the graph of FIG. 2. This means that it is possible to increase the light emission luminance of the LED backlight 8 up to around the LED duty of 55% by power limit control when the average lighting rate is 53% in a screen on which a video signal is displayed. The LED duty of 55% corresponds to about 1.5 times of the LED duty of 36.5% when completely lit (average lighting rate of 100%). That is, when the average lighting rate is 53% with respect to the LED duty of 36.5% when LEDs are completely lit, it is possible to supply power to the lighting LED to have light emission luminance which is 1.5 times of 36.5%.

In this manner, the above-described constant scale factor a is determined as 1.5 in this example. The actual luminance of the LED backlight 8 is strengthened by stretching the provisional lighting rate in each area only by the above-described constant scale factor a determined based on a value of possible maximum light emission luminance (maximum light emission luminance corresponding to the Max luminance described above), which is determined according to the average lighting rate, to become the above-described second luminance. The light emission luminance of the LED as a result of multiplying each of the areas A to H by a-times (the above-described second luminance) is as illustrated in FIG. 4.

The liquid crystal panel 9 is to be irradiated with the light emission luminance of the LED that is stretched in this manner. This state will be described with reference to FIG. 5. FIG. 5 is a diagram showing a state of display luminance (screen luminance) of the liquid crystal panel 9 when an LED duty is changed. In FIG. 5, a horizontal axis is a gray level of a video signal and a vertical axis is a display luminance value on the liquid crystal panel.

For example, when the LED of the LED backlight is controlled with the LED duty of 36.5%, gray level representation of the video signal becomes like T1. At this time, a luminance value on the liquid crystal panel=(gray level value)^{2.2} (that is, γ=2.2). Moreover, when the LED is controlled with the LED duty of 100%, gray level representation becomes like T2. That is, since the luminance of the LED is increased by about 2.7 times from 36.5% to 100%, the luminance value on the liquid crystal panel 9 is also increased by about 2.7 times. Thereby, it is possible to enhance feeling of brightness in all gray level areas.

At this time, the luminance is increased by about 2.7 times not only in a High area having high luminance for which feeling of brightness is desirably enhanced but in a Low area having a low gray level. Accordingly, though contrast of a video is improved, a disadvantage by stage increase of the luminance, such as black float in a low-gray-level area, is also caused.

Thus, it is preferable to reduce light emission luminance of the LED in a low-gray-level area in which screen luminance is not desirably further increased from a state where the light emission luminance of the LED is uniformly raised within an allowable power range by controlling the light emission luminance of the LED with power limit control, or increase the luminance by further allocating the reduced luminance to a high-gray-level area. By employing such control, it is possible to improve contrast to obtain a video having higher video quality.

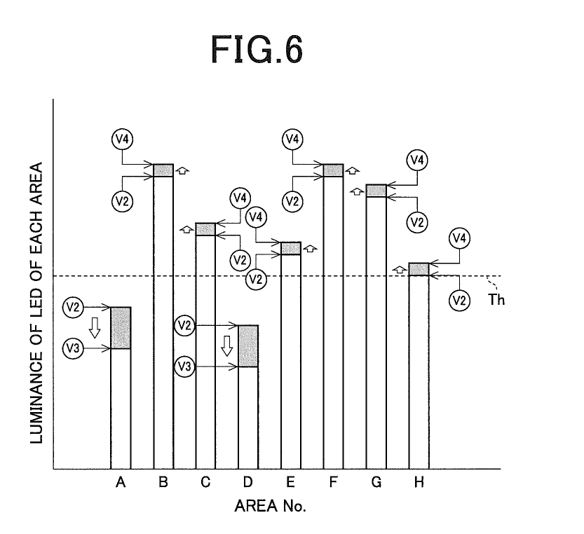

Description will be given for an example of such control with reference to FIG. 6.

FIG. 6 is a diagram showing another example of a result of applying local dimming under power limit control with respect to the respective areas A to H of FIG. 3. In FIG. 6, a horizontal axis is an area No. of the divisional area shown in FIG. 3 and a vertical axis is a luminance value of the LED of each divisional area. The luminance value of the LED is able to be expressed by a gray level value of 0 to 255.

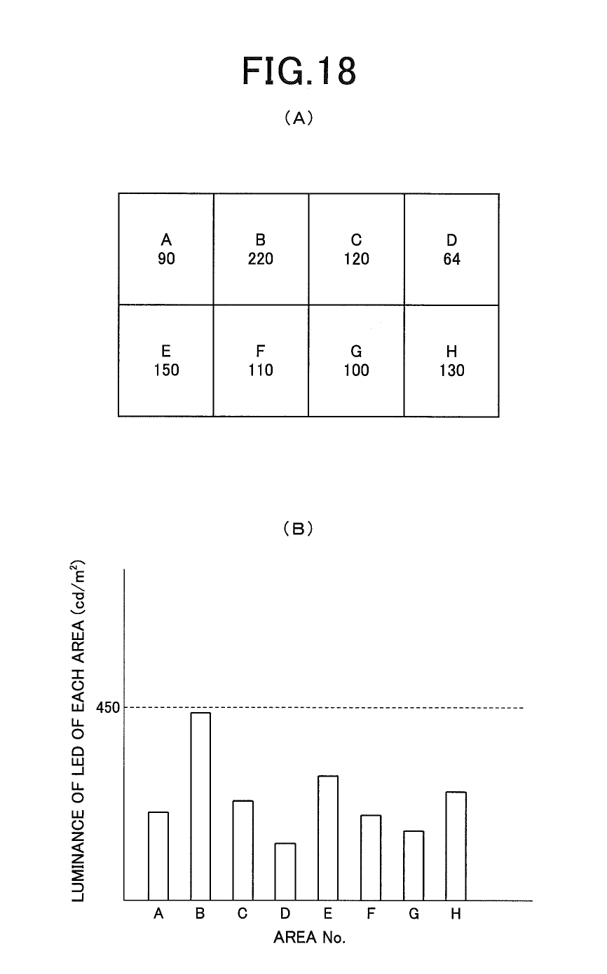

First, a luminance value of the LED in each divisional area is defined by a method same as the conventional local dimming control. This luminance value is set as first luminance. The first luminance is defined to be relatively small in an area having a small maximum gray level value of a video and defined to be relatively large in an area having a large maximum gray level value of the video (same tendency as FIG. 18 (B)). Thereby, in the same manner as the conventional one, black float in a low gray level is avoided, and contrast is improved as well as it is sought to reduce power consumption, for enhancing feeling of brightness by increasing luminance in a high-gray-level area. The luminance of the LED in each divisional area at this time is set so as not to exceed screen luminance when LEDs are completely lit (for example, 450 cd/m²).

Then, as described with reference to FIG. 4, the light emission luminance value of the LED in each area is multiplied by an increment of the luminance calculated by power limit control (here, 1.5 times). Here, a value of the increment of the luminance is multiplied uniformly with respect to all of the divisional areas. Though the LED duty when the LEDs are completely lit is 36.5% in the example described above, the light emission luminance of the LED rises up to the LED duty of 55% in the case of the average lighting rate of 53%. A value of histogram data that the first luminance is multiplied by 1.5 is set as second luminance (V2).

As a feature of exemplary control described in FIG. 6, the second luminance (V2) in each divisional area and a predetermined threshold (a gray level of LED luminance) Th are compared, and for the divisional area where the second luminance (V2) is smaller than the threshold Th, the second luminance (V2) is further reduced by a predetermined amount. For example, when the threshold Th is a gray level of 160, light emission luminance of the LED in the divisional area having the second luminance (V2) smaller than a gray level of 160 is reduced. The reduction value is set as, for example, 1/1.5=0.68 time. That is, third luminance (V3) is given by multiplying the initial luminance value (first luminance) by 1.5 and the resulting one (second luminance) is multiplied by 0.68 again. This leads to returning to the original luminance value (first luminance) of the LED consequently. However, the reduction value is not limited to such a value that returns to the original luminance value of the LED.

In this manner, in the control of the LED backlight 8, in the divisional area where the maximum gray level value is smaller than the threshold Th, the third luminance (V3) is used to control the LED. Thereby, in a video area with a low gray level having the maximum luminance value smaller than the threshold Th, even when power is supplied to the LED by power limit control, low luminance is maintained without excessively increasing the light emission luminance of the LED, resulting that contrast is further improved as well as degradation such as black float is solved.

At this time, when the third luminance (V3) is caused to match the first luminance, even in the case of luminance control by power limit control, it is possible to return to the first luminance as to the area having the maximum gray level value smaller than the threshold Th. Moreover, when the first luminance of the LED is increased uniformly to the second luminance by power limit control and the second luminance is compared to the threshold Th to reduce luminance of the LED in the divisional area having the maximum gray level value smaller than the threshold Th as described above, the third luminance may be set to be lower than a predetermined multiple of the first luminance and lower than the threshold Th so as to be close to the first luminance without matching the first luminance. For example, by reducing to be smaller than the threshold Th and within about twice of the first luminance, an effect of suppressing occurrence of noise that becomes prominent by mainly increasing luminance of a low-gray-level video is able to be obtained in addition to the effect of improvement of contrast.

In this manner, in the example of FIG. 6, the area active control portion 4 supplies power to the LED by power limit control with respect to the first luminance that the luminance of the LED with a low gray level is reduced in order to seek improvement of contrast and reduction of power saving based on the maximum gray level value (one example of the first feature amount) in the divisional area of the video to increase to the second luminance, compares the second luminance for each divisional area and the predetermined threshold Th, and only for the divisional area where the second luminance is lower than the threshold Th, reduces the second luminance again so as to be equal to the first luminance in this divisional area or to be lower than a predetermined multiple of the first luminance in this divisional area and lower than the threshold Th, for thereby setting as the third luminance.

Then, preferably, the area active control portion 4 may assign, to the divisional area where the second luminance is equal to or greater than the threshold Th, a total quantity of decrements of luminance in the divisional area where it is smaller than the threshold Th, increase the second luminance by the assigned luminance to set as fourth luminance, and control light emission of the LED for each divisional area using the third luminance and the fourth luminance. That is, a quantity of power that is able to be reduced by using the third luminance is assigned to the divisional area which is equal to or greater than the threshold Th to have the same power as the case of controlling with the second luminance. Such control makes it possible to cause a high-luminance area to have higher luminance while a low-luminance area remains dark to improve contrast.

As to a method for assigning, it is possible to perform assignment by allocating a total quantity of decrements of luminance to each area evenly. That is, the area active control portion 4 may perform assignment by distributing, evenly to the divisional area where the second luminance is equal to or greater than the threshold Th, a total quantity of decrements of light emission luminance in the divisional area where it is smaller than the threshold Th. In the exemplary control of FIG. 6, luminance of the equal quantity is assigned to the areas B, C, E, F, G and H where the second luminance is equal to or greater than the threshold Th to add to the second luminance. This value is the fourth luminance (V4). The quantity of luminance to be assigned is able to be expressed by a drive current value of the LED. That is, a total quantity of drive current values for a decrement of luminance is assigned to a drive current value of an area in which luminance is to be increased to increase the drive current value. This makes it possible to show a bright part on a video more clearly. It is suitable for a case where there are relatively many bright parts occupying such a video that displays a whitish house.

Moreover, the method for assigning may be that an assigning ratio is changed according to a value of the second luminance and a third feature amount (note that, a second feature amount will be described below) of a video indicated by a video signal after being synthesized with an OSD signal (an input video signal when an OSD image is not synthesized) corresponding to each of the divisional areas A to H. Here, the third feature amount is a maximum gray level value for each video frame or an APL for each video frame.

For example, when assigning, to the divisional area where the second luminance is equal to or greater than the threshold Th, a total quantity of decrements of light emission luminance in the divisional area where it is smaller than the threshold Th, the area active control portion 4 may increase a quantity of luminance to be assigned as the divisional area has relatively larger second luminance. By increasing the luminance in an area which includes the brightest part in a focused manner, it is possible to further improve feeling of gleaming brightness. This example is suitable for a case where a property of a gray level of a bright part such as fireworks is less concerned and brightness and level of luminance thereof are important. In this manner, when increasing the second luminance by the threshold Th, the area active control portion 4 may relatively increase the assigning quantity of luminance as the divisional area has relatively larger second luminance.

As to a source of assigning in this case, when reducing the second luminance by the threshold Th, the area active control portion 4 preferably reduces the second luminance so as to be close to the first luminance for the divisional area having the smaller second luminance among divisional areas where the second luminance is lower than the threshold Th. When reducing the second luminance to set as the third luminance, luminance of the LED may not be reduced uniformly with the constant scale factor but reduction scale factor (or a reduction quantity) of luminance of the LED may be differentiated according to the value of the second luminance like in this example among the divisional areas having the maximum gray level value smaller than the threshold Th (one example of the first feature amount).

Alternatively, when assigning, to the divisional area where the second luminance is equal to or greater than the threshold Th, a total quantity of decrements of light emission luminance in the divisional area where it is smaller than the threshold Th, it is possible to increase the quantity of luminance to be assigned for the divisional area having the relatively smaller second luminance. This makes it possible to show an area which includes a bright part more clearly while avoiding that white collapse or gray-level collapse occurs in the brightest part.

Moreover, among the light emission areas where the maximum gray level value is smaller than the threshold Th, the luminance of the LED may be reduced so as to be close to the first luminance for one having a smaller third feature amount. For example, in the case of a video in which a maximum gray level value of a video frame is relatively high, in the divisional area where the maximum gray level value (one example of the first feature amount) is smaller than the threshold Th, the luminance of the LED is returned to a predetermined multiple, for example, about twice of the first luminance, without returning to the first luminance. Then, the above-described decrement of the luminance is assigned to the divisional area having the maximum gray level value (one example of the first feature amount) which is equal to or greater than the threshold Th to further increase the luminance. As the maximum gray level value of the video frame is smaller, the decrement of the luminance for the divisional area where the maximum gray level value is smaller than the threshold Th is large, so that a total quantity of assigning the luminance for the area in which the luminance is enhanced also increases. Thereby, when the maximum gray level value of the video frame is small, it is possible to increase an increment of the luminance for apart which is more brilliant in a screen, to further enhance feeling of brightness and to improve contrast. Note that, this is the same also when an APL of the video frame is used as the third feature amount.

In this manner, the area active control portion 4 may reduce the second luminance so as to be close to the first luminance for a video in which the third feature amount of the video is smaller when reducing the second luminance by the threshold Th, and relatively increase a quantity of the luminance to be assigned for the divisional area having the larger third feature amount.

In addition, the light emission luminance of the divisional area which is smaller than the threshold Th may be only reduced and assigning to the divisional area which is equal to or greater than the threshold Th may not be executed. That is, the area active control portion 4 may compare the second luminance for each divisional area and the predetermined threshold Th, reduce the second luminance again only for the divisional area where the second luminance is lower than the threshold Th to set as the third luminance, and use the third luminance and the second luminance of the divisional area where the second luminance is not reduced to control light emission of the LED for each divisional area.

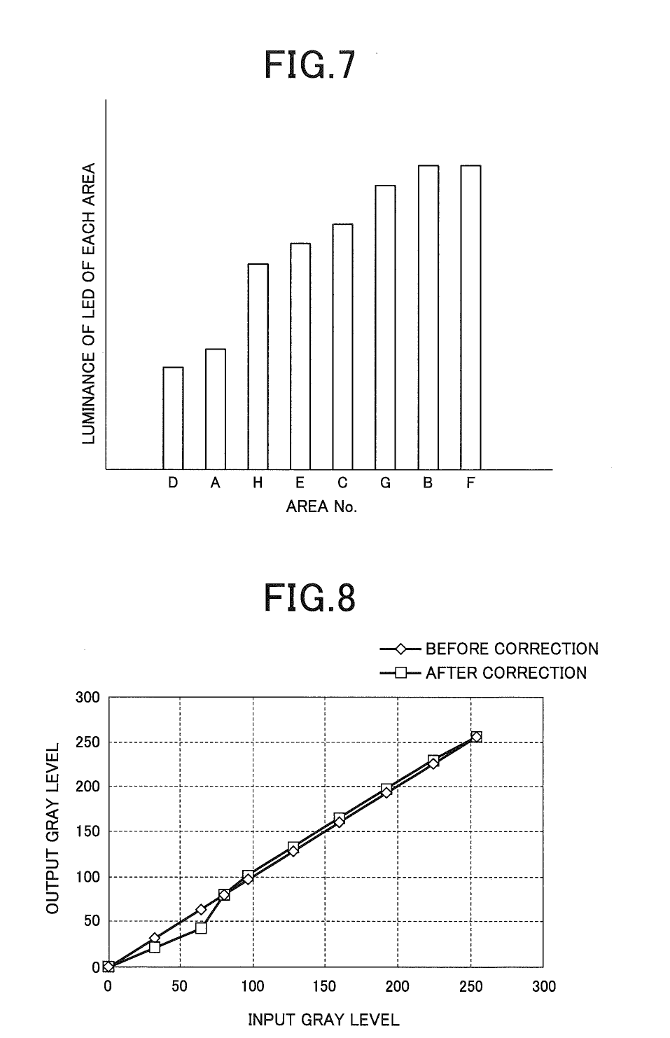

Next, description will be given for an effect in the exemplary control of FIG. 6 with reference to FIG. 7 and FIG. 8. FIG. 7 is a diagram in which light emission luminance of the LED obtained as a result of FIG. 6 is sorted in ascending order, and FIG. 8 is a diagram showing a gray level curve indicating light emission luminance of the LED in each divisional area with respect to a maximum gray level value in each divisional area, obtained from the light emission luminance of the LED of FIG. 7.

In the exemplary control of FIG. 6, the light emission luminance of the LED in an area having the maximum gray level value smaller than the threshold Th is reduced by employing any one of the above-described respective methods. The results thereof are rearranged in ascending order of the light emission luminance of the LED as shown in FIG. 7, and a gray level curve with the maximum gray level value in each divisional area as input and with the light emission luminance of the LED in each divisional area as output is created so as to match therewith, which then becomes as shown in FIG. 8.

In FIG. 8, a horizontal axis indicates an LED gray level value (input gray level) corresponding to the second luminance and a vertical axis indicates an LED gray level value (output gray level) corresponding to the third luminance. Moreover, in FIG. 8, before correction indicates a gray level curve when the second luminance is output without being corrected to the third luminance, and after correction indicates a gray level curve when the second luminance is corrected to the third luminance in accordance with threshold processing.

As shown in FIG. 8, in the gray level curve after correction, in the case of a low-gray-level area smaller than the predetermined threshold Th, control is performed such that the light emission luminance of the LED, whose luminance is increased by power limit, is reduced again. In other words, only for the low-gray-level area smaller than the predetermined threshold Th, the light emission luminance of the LED is not increased but maintained at a level same as or a level near the original luminance (first luminance) of the LED. This makes it possible to suppress occurrence of noise on display without excessively increasing the luminance of the LED only for the predetermined low-gray-level area and to perform video representation by further enhancing feeling of brightness in an area having high luminance. Note that, the same effect is basically exerted as to the low-gray-level area also in the example in which assigning is not executed.

In the example above, it is assumed that the area active control portion 4 sets the threshold Th as a fixed value regardless of a feature amount of a video. The gray level value of 160 is exemplified as the fixed value, but not limited thereto. For example, it is in an area having low luminance of a video signal that noise is to be a problem when the luminance of the LED is increased by power limit, and when the entire video signal is divided into high, middle and low luminance, almost 33% or less becomes a video having low luminance, so that this value of 33% (gray level value of 84) may be used as the threshold Th.

On the other hand, the fixed value may not be used for the threshold Th.

For example, the threshold Th may be one that is defined according to the number of areas in which the luminance is reduced among the divisional areas. That is, the area active control portion 4 may set the threshold Th so that the number of the divisional areas in which the second luminance is reduced to set as the third luminance is the predetermined number. Here, it is possible to set the threshold Th so that the second luminance is reduced to set as the third threshold only for the predetermined number from the divisional area having the low first feature amount (maximum gray level value or APL) among the plurality of divisional areas. For example, it is possible to set the third luminance only for two areas among the areas divided into eight. This makes it possible to suppress increase in the luminance of the LED at all times and to improve contrast for the constant number of areas having low luminance.

Moreover, the threshold Th may be changed dynamically according to the above-described third feature amount. That is, the area active control portion 4 may set the threshold Th according to the third feature amount of a video. As the third feature amount, as described above, the APL of the video frame, the maximum gray level value (peak value) of the video frame or the like is usable. Though description will be given below for a case where an APL of a video frame is employed as the third feature amount, the threshold Th may be set with the same way of thinking such as whether or not to reduce luminance also when a maximum gray level value of the video frame is employed.

Generally, there is a correlation to some extent between the APL of the video frame and the maximum gray level value of the divisional area (or the first feature amount such as the APL of the divisional area), which varies greatly depending on a video. Since the APL of the video frame is an average value of luminance of the entire video, the divisional area where the first feature amount of the divisional area (in particular, the maximum gray level value) is lower than the APL of the video frame has less part which is brilliant in the area, and is the area in which the luminance is to be reduced. Accordingly, with respect to the divisional area having the smaller first feature amount (in particular, the maximum gray level value) than the APL of the video frame, this threshold Th is set so that the second luminance value of the divisional area becomes smaller than the threshold Th. A decrement complies with any one of the above-described respective exemplary processing. By assigning the decrement of the luminance again to the area where the first feature amount is equal to or greater than the threshold Th, it is possible to enhance feeling of brightness for a part having high luminance and improve contrast.

Moreover, in the case of a video in which contrast of an entire video is extremely large, that is, when the maximum gray level value exceeds the APL of the video frame in all of the divisional areas, with respect to the divisional area having the larger maximum gray level value than the APL of the video frame, the threshold Th is set so that the second luminance of the divisional area becomes equal to or greater than the threshold Th. Thereby, in such a case, it is possible not to perform control for reducing again the luminance of the LED, whose luminance is increased by power limit, for any of the areas.

As above, in the description with reference to FIG. 2 to FIG. 8, it is assumed that the area active control portion 4 changes a lighting rate in an area of the light source corresponding to the divisional area based on the above-described first feature amount for each divisional area, obtains an average lighting rate that lighting rates of areas of the light source are averaged for all of the areas of the light source, and determines the above-described constant scale factor based on possible maximum display luminance on a screen of the display panel which is associated with the average lighting rate in advance. In the present invention, however, such a method for calculating the average lighting rate may not be employed and the above-described constant scale factor may not be determined according to the average lighting rate, and the above-described constant scale factor may be determined in a range where a total value of drive current of the LED is equal to or less than the predetermined allowable current value.

Next, description will be given for control of the video display device when displaying an OSD image as a main feature of the present invention with reference to FIG. 1. Note that, the area active control portion 4, the LED control portion 5, the liquid crystal control portion 6, the LED driver 7, the LED backlight 8 and the liquid crystal panel 9 perform basically the same processing regardless of display/non-display of an OSD image (synthesizing/non-synthesizing of an OSD signal). That is, various exemplary control described above is applicable to the backlight control portion described above regardless of display/non-display of an OSD image.

The OSD output portion 2 obtains the second feature amount of a video indicated by an input video signal (that is, a video of a synthesizing source) to be displayed in a display area corresponding to the divisional area (the divisional area of the LED backlight 8) in which a display area of an OSD image (hereinafter, referred to as an OSD display area) is included. That is, the OSD output portion 2 obtains the second feature amount of a video before synthesizing to be displayed in the display area matching “the divisional area of the LED in which the OSD display area is included among the divisional areas of the LED backlight 8”. Note that, the second feature amount is obtained for the video before synthesizing as described above, and is not obtained for a video after the OSD image is synthesized (that is, the video indicated by a video signal after the OSD signal is synthesized). Hereinafter, the display area corresponding to the divisional area in which the OSD display area is included is referred to as “an OSD-containing area”, and a video before synthesizing to be displayed in the ODS-containing area is referred to as “an OSD-containing area video”.

The OSD output portion 2 in the exemplary configuration of FIG. 1 is to obtain the second feature amount of an output video from the image processing portion 1 as described above. As the above-described second feature amount, a maximum gray level value of the OSD-containing area video or an average gray level value of the OSD-containing area video are able to be employed. This average gray level value may be said as an APL of the OSD-containing area video, and as an example of the APL, an average luminance level of the OSD-containing area video is also able to be employed.

Further, the OSD output portion 2 determines an OSD signal by using gray level data that is associated with the above-described second feature amount in advance, and outputs the OSD signal. Description will be given below for an example in which the maximum gray level value is employed as the second feature amount. An average lighting rate in the OSD-containing area is calculated from the maximum gray level values for each divisional area of the OSD-containing area video, and the OSD signal having gray level data that is associated as being closest to the calculation result (here, data indicating the maximum gray level value) is output. The gray level data is data indicating a gray level value of the OSD image also as shown from being data used for determining the OSD signal. Accordingly, the gray level data may be (i) OSD image data itself prepared for each OSD image to be displayed and for each gray level, or may be (ii) data indicating the maximum gray level value among gray level values of characters and a background of the OSD image.

(i) When the OSD image data (OSD signal) itself is used as the gray level data, OSD image data that is associated in advance with the maximum gray level value of the OSD-containing area video, which is one example of the above-described second feature amount, may be read and output. More specifically, the maximum gray level value is detected for each divisional area of the OSD-containing area video, and an average value when the respective maximum gray level values are converted into provisional lighting rates (average lighting rate) is calculated. Then, among data of patterns of the OSD image that are prepared by a plurality of pieces for OSD display, data that is associated as having a gray level closest to the average lighting rate that is detected in the previous stage is searched and output.

(ii) When data indicating the maximum gray level value of a background and characters is used as the gray level data, the OSD output portion 2 may use the maximum gray level value of the background and the characters, which is associated in advance with the maximum gray level value of the OSD-containing area video (or the average lighting rate that is calculated as described above) to determine and output the OSD signal so that the OSD image is displayed with the maximum gray level value. Actually, the maximum gray level value of the background and the characters may match the maximum gray level value of the OSD-containing area video, but in a case where only the gray level of the background is changed and the gray level of the characters is fixed in the OSD image, when the gray level of the characters is proximate to the gray level of the background surrounding the characters, it may occur that the characters are blended into the gray level of the surrounding background and the characters become unable to be viewed. Accordingly, it is preferable that not only the condition such that the maximum gray level value of the background and the characters matches the maximum gray level value of the OSD-containing area video, but the data that is varied by causing the gray level of the characters to be coupled with the gray level of the background of the OSD image is used in order to ensure visibility of the characters in the OSD image. Note that, since the OSD image which may be a display target is normally unable to be represented in a single color, of course, the gray level data is to include data of gray level values for the respective primary colors (such as 3 primary colors of red, green and blue or 4 primary colors with yellow added, which is employed in recent years) of the liquid crystal panel 9. Moreover, the gray level data may be data indicating one color, for example, among color palettes of 256 colors.

In this manner, the OSD output portion 2 uses the gray level data matching the maximum gray level value of the OSD-containing area video (or the average lighting rate that is calculated as described above), which is one example of the second feature amount obtained for the OSD-containing area video, selects (or changes) the gray level of the OSD image and determines and outputs an OSD signal. The output OSD signal is synthesized with a video signal from the image processing portion 1 at the synthesizing portion 3, and after through control in the area active control portion 4, displayed on the liquid crystal panel 9.

At that time, light emission control is performed for each divisional area of the LED backlight 8 by applying power limit control based on the first feature amount at the area active control portion 4. However, since the OSD image indicated by the OSD signal determined as described above is that the gray level data is determined so that the OSD-containing area video becomes similar to or matches a feature amount thereof, the first feature amount for the video in which the OSD-containing area video and the OSD image are synthesized is not much changed from the first feature amount for the OSD-containing area video. Thus, when the OSD image whose gray level is changed like in the present invention is synthesized, light emission control based on the first feature amount in the area active control portion 4 is not affected and becomes the same light emission control as the case when the OSD image is not synthesized, so that the luminance does not change. In particular, by employing the same feature amount (such as the maximum gray level value or the APL) for the second feature amount and the first feature amount, light emission control is able to be completely unaffected by synthesizing of the OSD image. Among them, since it is preferable to use the maximum gray level value as the first feature amount for enhancing feeling of brightness of the high-luminance video, it may be said that it is preferable to employ the maximum gray level values in the first and second feature amounts as illustrated.

Moreover, it is preferable that the gray level data is stored as the table (hereinafter, gray level table) 2b in association with the second feature amount in advance, and based on the obtained second feature amount, the OSD output portion 2 determines the OSD signal by referring to this gray level table 2b. As the gray level table 2b, a range which is possibly taken as a value of the second feature amount may be delimited into a plurality of pieces to allocate one gray level data for each delimitation.

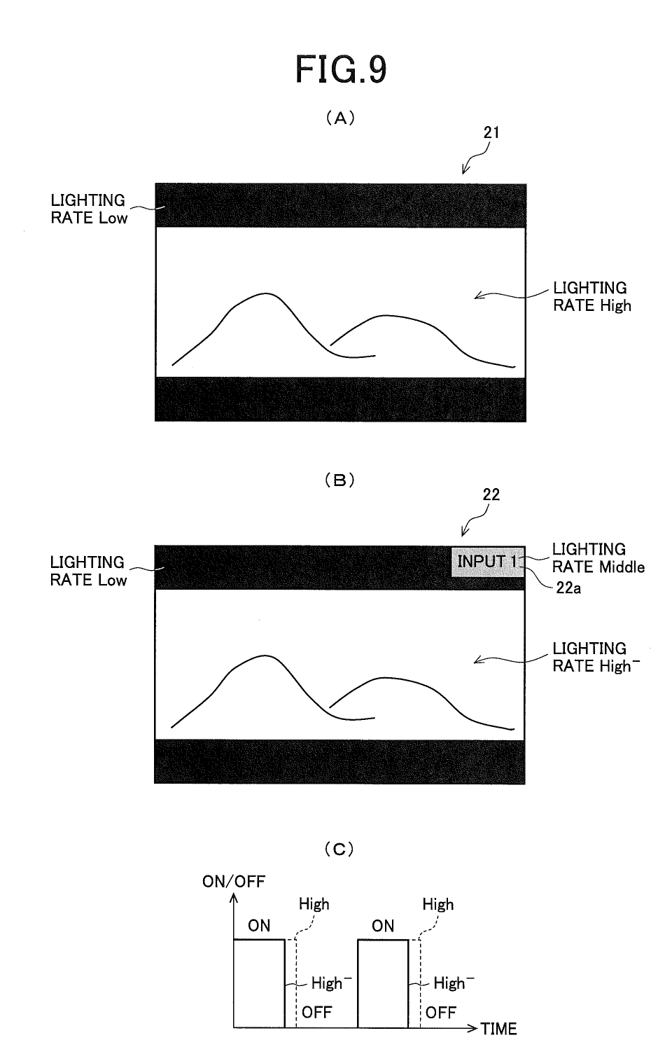

Description will hereinafter be given for exemplary processing in the OSD output portion 2 and an effect thereof with reference to FIG. 9 to FIG. 16 in combination, by taking an example in which a maximum gray level value is employed as the second feature amount of an OSD-containing area video and the gray level table 2b is used, in the same manner as the example described above.

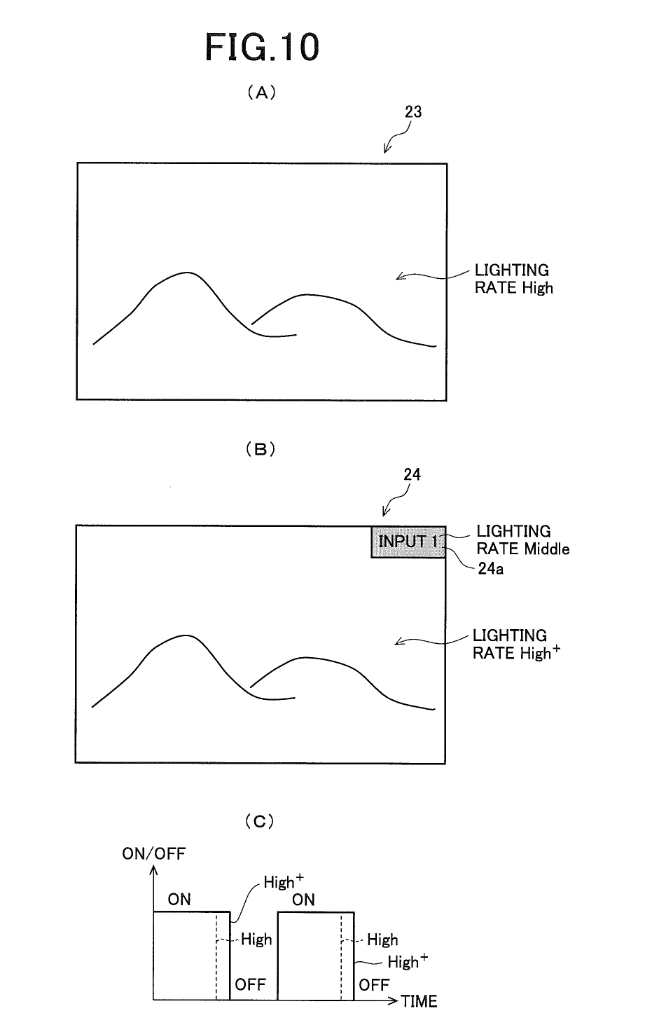

First, description will be given for a case where an OSD image is displayed as it is in accordance with a user operation and default setting like the conventional area active drive, with reference to FIG. 9 and FIG. 10. FIG. 9 is a diagram describing a result of conventional area active drive when a maximum gray level value of an OSD-containing area video is low, and FIG. 10 is a diagram describing a result of the conventional area active drive when a maximum gray level value of an OSD-containing area video is high. Note that, the result described here becomes the same also when luminance control, which has been described as control mainly in the area active control portion 4 with reference to FIG. 1, is performed (however, when processing for determining gray level data at the OSD output portion 2, which is a feature of the present invention, is not performed).

In the case of a video which has black band areas and has a bright area in the other part like a video 21 illustrated in FIG. 9(A), the provisional lighting rate is low in the black band areas and high in the bright area, and the lighting rate after luminance stretching also has the same tendency. With respect to such a video 21, like a video 22 illustrated in FIG. 9(B), when an OSD image 22a is displayed by a user operation or the like, the lighting rate after stretching remains low in the black band areas and is in a middle extent in a display area of the OSD image 22a, but becomes slightly low in the above-described bright area compared to a case of the video 21 whose LED duty is schematically shown in FIG. 9(C), so that peak luminance is reduced. This is because the maximum gray level value of the OSD-containing area video for the OSD image 22a is lower than the maximum gray level value of the OSD image 22a itself and therefore the lighting rate in the OSD-containing area is to be increased in accordance with display of the OSD image 22a, while the lighting rate in the above-described bright area is to be reduced only by the increment so that power becomes equal before and after OSD display by power limit control.

On the other hand, in the case of a video in which an entire area is a bright area like a video 23 illustrated in FIG. 10(A), the provisional lighting rate is high in the entire area and the lighting rate after luminance stretching is slightly reduced but becomes a high state almost evenly in the entire area. With respect to such a video 23, when an OSD image 24a (which is set as the same image as the OSD image 22a) is displayed like a video 24 illustrated in FIG. 10(B) by a user operation or the like, the lighting rate after stretching becomes slightly high in the above-described bright area compared to a case of the video 23 whose LED duty is schematically shown in FIG. 10(C), so that peak luminance is increased. This is because the maximum gray level value of the OSD-containing area video for the OSD image 24a is higher than the maximum gray level value of the OSD image 24a itself and therefore the lighting rate in the OSD-containing area is to be decreased in accordance with display of the OSD image 24a, while the lighting rate in the above-described bright area is to be increased only by the decrement so that power becomes equal before and after OSD display by power limit control.

As described in FIG. 9 and FIG. 10 and as described as a problem of the present invention, when area active drive is performed while performing power limit control, peak luminance changes depending on existence or non-existence of an OSD image. Note that, an upper limit of power does not change if power limit control is performed, but in a case where the APL of a video frame is low, such as a case where a video signal indicating black for an entire screen is input, excess power is only required by control for increasing light emission luminance in order to display a display area of the OSD image brightly, so that power consumption is increased.

Against this, in the present invention, in order to suppress such change of peak luminance and the increase in power consumption when the APL of a video frame is low, caused by a difference of display/non-display of OSD, a gray level of an OSD image is determined in the OSD output portion 2 and such an OSD image is displayed.

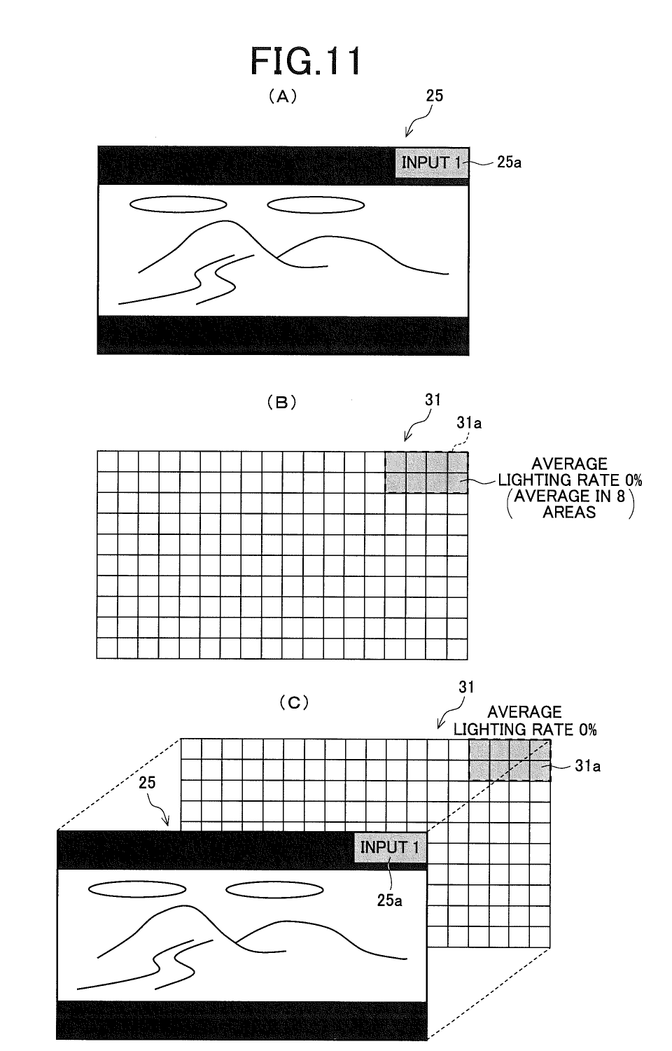

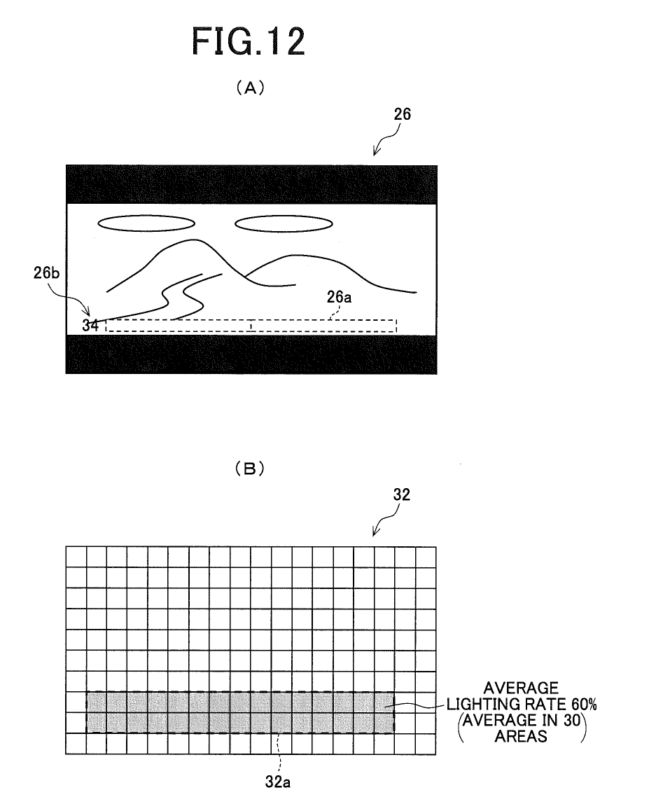

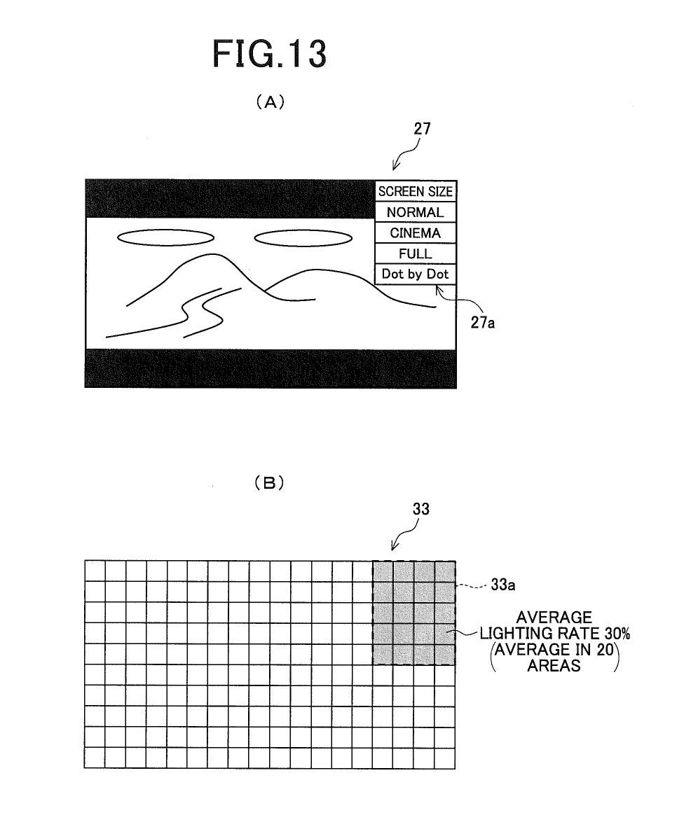

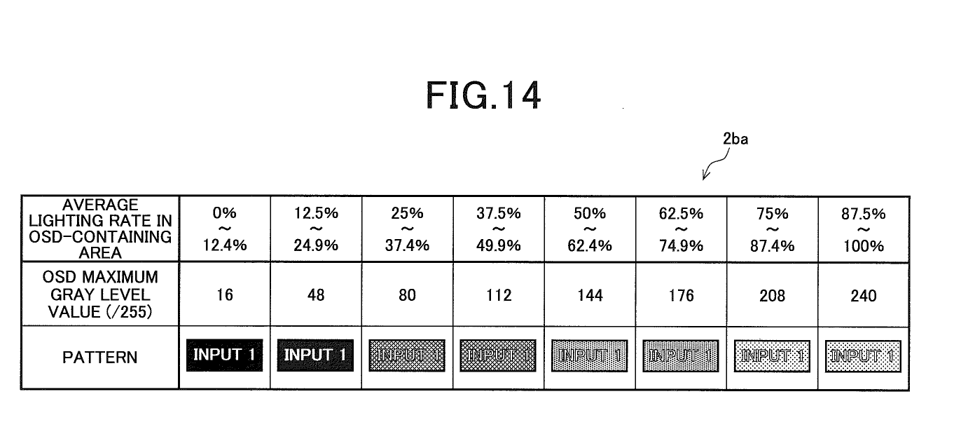

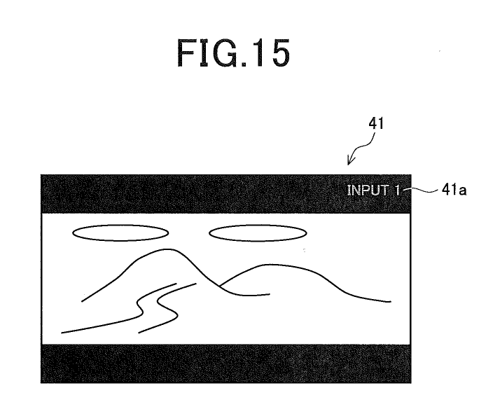

Description will be given for specific exemplary processing of the present invention with reference to FIG. 11 to FIG. 15. FIG. 11 is a diagram describing exemplary processing in the OSD output portion of the video display device of FIG. 1, and FIG. 12 and FIG. 13 are diagrams describing exemplary processing when an OSD image, which is different respectively, is displayed. Further, FIG. 14 is a diagram showing one example of the gray level table in the video display device of FIG. 1, and FIG. 15 is a diagram showing one example of a video that is output by using the gray level table of FIG. 14.

A case where a video 25 with which an OSD image 25a is synthesized as illustrated in FIG. 11(A) is displayed is taken as an example. First, a video signal before synthesizing, which is output from the image processing portion 1, is to be input not only to the synthesizing portion 3 but also to the OSD output portion 2. Note that, all video signals subjected to video signal processing at the image processing portion 1 may not be output to the OSD output portion 2, and the video signals to which the image processing portion 1 applied the video signal processing may be stored in a video frame memory and only a video signal (that is, a video signal of an OSD-containing area video) corresponding to a necessary display area (that is, an OSD-containing area) may be output to the OSD output portion 2 according to a request from the OSD output portion 2.

The maximum gray level value detecting portion 2a of the OSD output portion 2 inputs the video signal subjected to the video signal processing at the image processing portion 1 and calculates a maximum gray level value of the OSD-containing area video. In the maximum gray level value detecting portion 2a, from the OSD image 25a which has become a display target by a user operation, default setting or the like, a display area thereof may be obtained, and divisional areas of the LED backlight 8 having the minimum number, which contain the OSD display area (eight divisional areas 31a shown in FIG. 11(B)), may be obtained to determine the OSD-containing area as the same area as the divisional areas. Note that, FIG. 11(C) shows a correspondence relation of the video 25 of FIG. 11(A) and divisional areas 31 of the LED backlight 8 of FIG. 11(B), which shows an example in which the eight divisional areas 31a (=OSD-containing area) are different from the OSD display area, but there is also a case where they are same depending on the OSD image. Since the eight divisional areas 31a are in a black band area, the maximum gray level value detecting portion 2a outputs the average lighting rate of 0% in the OSD-containing area as a detection result.

In a video 26 illustrated in FIG. 12(A), an indicator showing a sound volume value and a sound volume value of “34” are respectively displayed as OSD images 26a and 26b. As to this video 26, as shown in FIG. 12(B), among divisional areas 32 of the LED backlight 8, the divisional areas of the LED backlight 8 having the minimum number, which contain the OSD display area, are parts indicated by thirty divisional areas 32a, and the OSD-containing area becomes a display area matching therewith, as well. Here, an example in which the average lighting rate in this OSD-containing area is 60% is taken.

In a video 27 illustrated in FIG. 13(A), a menu image is displayed as an OSD image 27a. As to this video 27, as shown in FIG. 13(B), among divisional areas 33 of the LED backlight 8, the divisional areas of the LED backlight 8 having the minimum number, which contain the OSD display area, are parts indicated by twenty divisional areas 33a, and the OSD-containing area becomes a display area matching therewith, as well. Here, an example in which the average lighting rate in this OSD-containing area is 30% is taken.

Moreover, if slight deterioration of calculation accuracy of a maximum gray level value is permitted, the maximum gray level value detecting portion 2a may input a video signal separated from a broadcast signal or a video signal input from external equipment without through the image processing portion 1. Note that, though not specifically described in particular, the OSD output portion 2 may be configured so as to be able to obtain the second feature amount such as the maximum gray level value for an output video from the image processing portion 1. Accordingly, it is also possible to be configured so that without including the maximum gray level value detecting portion 2a in the OSD output portion 2, processing such as returning the second feature amount in accordance with designation of an OSD-containing area from the OSD output portion 2 is executed by the image processing portion 1 or the area active control portion 4. For example, it may be set that a maximum gray level value in an OSD-containing area for a last video frame is received from the area active control portion 4.

After the processing for detecting the maximum gray level value, the OSD output portion 2 refers to a gray level table 2ba as illustrated in FIG. 14 based on the maximum gray level value of the OSD-containing area video detected by the maximum gray level value detecting portion 2a (here, the average lighting rate in the OSD-containing area). As the gray level table 2ba, as illustrated in FIG. 14, a range which is possibly taken as a value of the average lighting rate may be delimited into a plurality of pieces to allocate one gray level data for each delimitation. In the gray level table 2ba of FIG. 14, the average lighting rate in the OSD-containing area is delimited into eight with an interval of 12.5% and the OSD maximum gray level value is allocated to each of them, in which the OSD maximum gray level value is reduced as the average lighting rate in the OSD-containing area is lower, and the OSD maximum gray level value is increased as the average lighting rate in the OSD-containing area is higher. In the gray level table 2ba of FIG. 14, a display pattern of the OSD image is also associated with the OSD maximum gray level value, so that the display pattern of the OSD image is able to be read directly from the average lighting rate in the OSD-containing area.

By referring to the gray level table 2ba of FIG. 14, the OSD output portion 2 searches the OSD maximum gray level value which is closest to the calculated average lighting rate or which is allocated to the corresponding average lighting rate in advance (the maximum gray level value in a set of a background gray level and a character gray level) from among a plurality of average lighting rates prepared for the OSD image, determines as an OSD signal by using it, and outputs the OSD signal.

In the example of FIG. 11, since the detected average lighting rate is 0%, a gray level of the OSD image 25a is set to a low gray level (OSD maximum gray level value 16), so that the OSD image 25a is displayed without changing peak luminance of the video 25. Thereby, a video 41 which includes an OSD image 41a having a low gray level, which is illustrated in FIG. 15, is displayed with respect to the video 25 which includes the OSD image 25a illustrated in FIGS. 11(A) and (C). For description, however, characters are illustrated slightly light so as to be viewed easily in the OSD image 25a of FIG. 15, but actually has a low gray level like a pattern in a leftmost end of the gray level table 2b1 of FIG. 14. In addition, it is possible to reduce power by such processing depending on setting of an upper limit of power limit control.

In the case of the example shown in FIG. 12, since the detected average lighting rate is 60%, gray levels of OSD images 26a and 26b are set to gray levels slightly higher than a medium degree (OSD maximum gray level value 144), so that it is possible to display the OSD images 26a and 26b without changing peak luminance from a video before synthesizing. In this case as well, it is possible to reduce power by such processing depending on setting of an upper limit of power limit control. Moreover, in the case of the example shown in FIG. 13, since the detected average lighting rate is 30%, a gray level of an OSD image 27a is set to a gray level slightly lower than a medium degree (OSD maximum gray level value 80), so that it is possible to display the OSD image 27a without changing peak luminance from a video before synthesizing. In this case as well, it is possible to reduce power by such processing depending on setting of an upper limit of power limit control.

In the OSD output portion 2, by employing such a method for determining an OSD signal, an OSD signal in which the OSD maximum gray level value is appropriately selected is able to be output to the synthesizing portion 3 so as to match control at the backlight control portion described above, in particular at a part of the area active control portion 4 for generating LED data. Accordingly, according to the present invention, in the video display device of area active drive, while power limit control is being performed, a bright video is made much brighter so as to improve contrast and enhance feeling of brightness for a high-luminance video and further, even when an OSD image is displayed, display quality is prevented from being degraded.

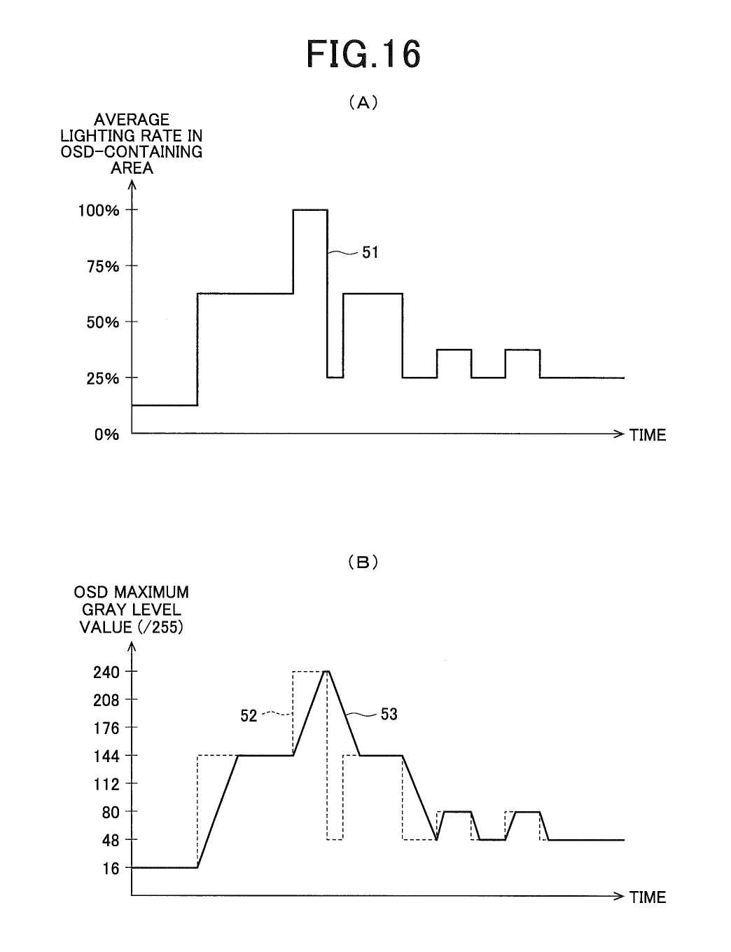

FIG. 16 is a diagram describing a function of a temporal filter that is able to be incorporated in the video display device of FIG. 1. FIG. 16(A) shows one example of an average lighting rate in an OSD-containing area which changes chronologically in an OSD-containing area video (corresponding to a maximum gray level value of the OSD-containing area video), and FIG. 16(B) shows one example of a maximum gray level value of an OSD image, which is determined, after smoothing by applying a temporal filter for the average lighting rate of FIG. 16(A), based on the smoothed average lighting rate. Note that, the average lighting rate determined based on the maximum gray level value is expressed with % in FIG. 16(A) and the maximum gray level value of the OSD image is expressed with a gray level value of 0 to 255 in FIG. 16(B).

In the present invention, when an input video signal is a moving image, the gray level of the OSD image is also to change consecutively in accordance with that the average lighting rate changes consecutively. However, like a time-series graph 51 of the average lighting rate shown in FIG. 16(A), the maximum gray level value of the OSD-containing area video does not change gently but changes drastically in some cases. In such a case, like a time-series graph 52 of the OSD maximum gray level value shown with a dotted line in FIG. 16(B), the OSD maximum gray level value also changes drastically and switching of the gray level of the OSD image becomes prominent, so that appearance quality of a video is to be degraded.

Against this, by passing the temporal filter for smoothing the time-series variation in the maximum gray level value of the OSD-containing area video (one example of the second feature amount), like a time-series graph 53 of the maximum gray level value of the OSD-containing area video for which temporal filtering is performed, which is shown with a solid line in FIG. 16(B), such switching of the gray level is able to be made less prominent. The time-series graph 53 shows a case where, for example, a filter which gives a restriction so as not to change the gray level of the OSD image only up to a predetermined step for one second is provided as the temporal filter. Note that, the temporal filter, though not shown, may be provided inside the video display device, for example, such as in the image processing portion 1 or the maximum gray level value detecting portion 2a of FIG. 1.

In this manner, the OSD output portion 2 in the video display device of the present invention performs processing not by causing the gray level of the OSD image to instantaneously follow temporal change of the average lighting rate in the OSD-containing area but by passing the temporal filter for changing in a stepwise manner, to make the change in the gray level of the OSD image difficult to be recognized. That is, the OSD output portion 2 uses gray level data which is associated in advance with the above-described second feature amount after passing the temporal filter to determine and output the OSD signal. This makes it possible to improve video quality.

Moreover, such temporal filtering processing may be executed may be executed, after judging whether the input video signal is a moving image or a still image, only when the result shows a moving image. Judging of a moving image/a still image may be performed, for example, based on which an input source is among any one of wireless equipment or the like which receives an image of a mobile terminal such as a PC, a TV tuner or a smartphone, that is, based on the input source. For example, it is judged as a still image in the case of the PC, and temporal filtering processing may not be executed, and it is judged as a moving image in other cases, temporal filtering processing may be executed.

As above, the average lighting rate in the OSD-containing area is calculated from the maximum gray level value of the OSD-containing area video, which is one example of the second feature amount, and an OSD signal which has the maximum gray level value closest to the calculation result is output, and, next, description will be given briefly for a case where the second feature amount is an average gray level value. In this case, the average lighting rate in the OSD-containing area may be calculated from the average gray level value of the OSD-containing are video, and an OSD signal which has the average gray level value (hereinafter, APL) closest to the calculation result may be output.

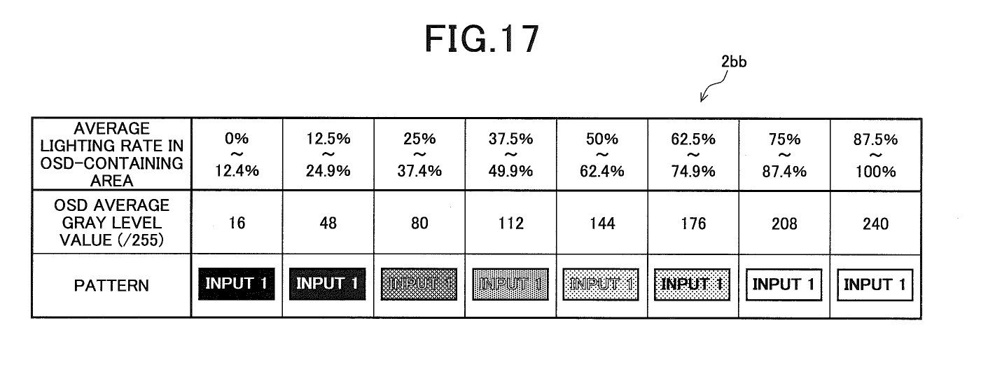

Description will be given for another example of a gray level table in the video display device of FIG. 1 with reference to FIG. 17. After processing for detecting the APL is performed at an APL detecting portion which is provided instead of the maximum gray level value detecting portion 2a, the OSD output portion 2 refers to a gray level table 2bb as illustrated in FIG. 17 based on the detected APL of the OSD-containing area video (here, the average lighting rate in the OSD-containing area). As the gray level table 2bb, a range which is possibly taken as a value of the average lighting rate may be delimited into a plurality of pieces to allocate one gray level data for each delimitation as illustrated in FIG. 17. In the gray level table 2bb of FIG. 17, the average lighting rate in the OSD-containing area is delimited into eight with an interval of 12.5% and the average gray level value is allocated to each of them, in which the OSD average gray level value is reduced as the average lighting rate in the OSD-containing area is lower, and the OSD average gray level value is increased as the average lighting rate in the OSD-containing area is higher. In the gray level table 2bb of FIG. 17, a display pattern of the OSD image is also associated with the OSD average gray level value, so that the display pattern of the OSD image is able to be read directly from the average lighting rate in the OSD-containing area.

By referring to the gray level table 2bb of FIG. 17, the OSD output portion 2 searches the OSD average gray level value which is closest to the calculated average lighting rate or which is allocated to the corresponding average lighting rate in advance (the average gray level value in a set of background a gray level and a character gray level) from among a plurality of average lighting rates prepared for the OSD image, determines as an OSD signal by using it, and outputs the OSD signal.

As above, description has been given for control of the OSD output portion 2 assuming that the second feature amount as to the OSD-containing area video is obtained, but the second feature amount may be obtained as to a video indicated by an input video signal (input video signal before the OSD signal is synthesized) to be displayed in the OSD display area instead. That is, the OSD output portion 2 may obtain the second feature amount as to a video before synthesizing to be displayed in the OSD display area, as to an output video from the image processing portion 1 in the example of FIG. 1. In this case as well, the APL in the OSD display area or the maximum gray level value in the OSD display area (however, a value of a video before the OSD image is synthesized in either case) is able to be employed as the second feature amount, and also as to other processing, basic processing is as described above and only a range where the second feature amount is obtained is different.

Moreover, as described above, the above-described first feature amount and the above-described second feature amount are able to be the same feature amount and gray level data of an OSD image is able to be determined with the same criteria as control in the area active control portion 4, which is preferable because synthesizing of the OSD image is easily made not to affect light emission control in the area active control portion 4 at all. In particular, both the above-described first feature amount and the above-described second feature amount are preferably set to be maximum gray level values of a video or average gray level values of the video. Of course, the above-described first feature amount may be the maximum gray level value of a video, which is generally used for control in the area active control portion 4, while the above-described second feature amount may be the average gray level value of the video. Even when different feature amounts are employed between the first feature amount and the second feature amount, if gray level data which corresponds to the second feature amount is prepared in advance so as to be in accordance with a correlation between the first feature amount and the second feature amount, for example, a correlation between the average gray level value and the maximum gray level value, synthesizing of the OSD image is almost able to be prevented from affecting light emission control in the area active control portion 4.

Though description has been given for the video display device of the present invention with reference to FIG. 1 to FIG. 18, when such a video display device is configured as a television receiving device, means for selecting and demodulating a broadcast signal received by an antenna for decoding and generating a reproduction video signal may be included in the television receiving device to input the reproduction video signal to the image processing portion 1 of FIG. 1. This makes it possible to display the received broadcast signal on the liquid crystal panel 9. The present invention is able to be configured as the video display device and the television receiving device including the video display device.

According to this television receiving device, because of including the video display device which exerts an effect as described above, it is possible that when performing area active drive while power limit is being applied, a bright video is made much brighter so as to improve contrast and enhance feeling of brightness for a high-luminance video and further, even when an OSD image is displayed, display quality is prevented from being degraded.

### EXPLANATIONS OF LETTERS OR NUMERALS

1 . . . image processing portion, 2 . . . OSD output portion, 2a . . . maximum gray level value detecting portion, 2b, 2ba and 2bb . . . gray level table, 3 . . . synthesizing portion, 4 . . . area active control portion, 5 . . . LED control portion, 6 . . . liquid crystal control portion, 7 . . . LED driver, 8 . . . LED backlight, and 9 . . . liquid crystal panel.

1-10. (canceled)

11. A video display device, comprising:
an OSD output portion that outputs an OSD signal for displaying an OSD image; a synthesizing portion that synthesizes an input video signal and the output OSD signal; a display panel that displays a video in which the OSD image is superimposed on a video indicated by the input video signal based on the video signal synthesized in the synthesizing portion; a backlight that uses an LED as a light source for illuminating the display panel; and a backlight control portion that controls light emission of the LED for each of divisional areas which are areas that the backlight is divided into a plurality of areas,
the backlight control portion defining luminance of the LED according to a first feature amount of the video indicated by the synthesized video signal that is to be displayed in a display area corresponding to the divisional area, and luminance of a part of the LED being set so as to be luminance or more in the case of a video with white 100%, wherein
the OSD output portion obtains a second feature amount for the video indicated by the input video signal that is to be displayed in a display area of the OSD image, or a second feature amount for the video indicated by the input video signal that is to be displayed in a display area corresponding to the divisional area in which the display area of the OSD image is included, and uses gray level data associated with the second feature amount in advance to determine and output the OSD signal.

12. The video display device according to claim 11, wherein
a table in which the gray level data is associated with the second feature amount is included, and
the OSD output portion determines and outputs the OSD signal by referring to the table.

13. The video display device according to claim 11, wherein
the gray level data is data indicating gray level values of a background and a character, and
the OSD output portion uses the gray level values of the background and the character associated with the second feature amount in advance to determine and output the OSD signal so that the OSD image is displayed with the gray level values of the background and the character.

14. The video display device according to claim 11, wherein
a temporal filter for smoothing time-series variation in the second feature amount is included, and
the OSD output portion uses the gray level data associated with the second feature amount in advance after passing through the temporal filter to determine and output the OSD signal.

15. The video display device according to claim 11, wherein
both the first feature amount and the second feature amount are maximum gray level values of the video or average gray level values of the video.

16. The video display device according to claim 11, wherein
the first feature amount is a maximum gray level value of the video and the second feature amount is an average gray level value of the video.

17. The video display device according to claim 11, wherein
the backlight control portion changes lighting rates in areas of the light source corresponding to the divisional areas based on the first feature amount for each of the divisional areas,
obtains an average lighting rate that lighting rates of the areas of the light source are averaged for all areas of the light source, and
determines the constant scale factor based on possible maximum display luminance on a screen of the display panel, which is associated with the average lighting rate in advance.

18. A television receiving device including the video display device according to claim 11.
